(19) United States
(12) Patent Application Publication
(10) Pub. No.: US 2017/0357847 A1
(43) Pub. Date: Dec. 14, 2017

(54) BIOLOGICALLY INSPIRED APPARATUS AND METHODS FOR PATTERN RECOGNITION

(71) Applicant: Marwan Anwar Jabri, Belvedere Tiburon, CA (US)

(72) Inventor: Marwan Anwar Jabri, Tiburon, CA (US)

(73) Assignee: Marwan Jabri, Belvedere Tiburon, CA (US)

(21) Appl. No.: 15/616,902

(22) Filed: Jun. 7, 2017

Related U.S. Application Data
(60) Provisional application No. 62/348,734, filed on Jun. 10, 2016.

(51) Int. Cl. G06K 9/00; G06T 7/13; G06K 9/62

(52) U.S. Cl. CPC G06K 9/00302; G06K 9/6267; G06T 7/13

(57) ABSTRACT

An apparatus for and a method of object recognition in images and sequences of images by producing enhancements of an input digital image using digital image processing, detecting objects in the enhanced images using a detector that can determine locations of objects, consolidating detected object locations using heuristic methods, validating whether or not a detected object is an object using a classifier, and recognising using the input image and the location of a validated detected object the category and/or the category probability measure of the object. For sequence of images, an apparatus for and a method of recognizing objects in sequence of images, by further assigning a detected object an owner entity, detecting and correcting a category misclassification in sequences of three or more images comprising object classification categories of same owner entity. The invention is applied to human facial emotion recognition in images and sequence of images.

### RELATED APPLICATION

The present invention claims priority of U.S. Provisional Patent Application No. 62/348,734, filed 2016 Jun. 10 titled “Biologically Inspired Apparatus and Methods for Pattern Recognition”, the contents of which are incorporated herein by reference in any jurisdiction where incorporation by reference is permitted.

### FIELD OF THE INVENTION

The present invention relates to the field of pattern recognition and classification, architectures for pattern recognition method and systems, the optimization of such architectures through machine learning, the recognition of human expressions in images and sequences of images.

### BACKGROUND

The present invention relates to the reliable recognition of objects in digital images (e.g. pictures) and sequences of digital images (e.g. videos). We will use the term video to refer to a moving-pictures and sequence of digital images, and the term image and picture interchangeably. Object recognition is an important step in pattern recognition where the objective is to locate and identify the category (e.g. label or class) of one or more objects in a single or multi-dimensional signal. Systems to recognize patterns in signals require many steps, including the localisation of patterns, extracting features associated with the patterns, and using the features for recognising the pattern. Artificial neural networks (ANNs) are becoming increasingly popular as a pattern recognition tool. The recognition of objects in pictures and videos using artificial neural networks heavily depends on the type of network architecture used for pattern recognition and classification. The inputs to such networks are typically images, sequence of images (e.g. videos), or features extracted from such images containing the patterns that need to be recognized. Such networks typically have multiple layers of artificial neurons. We will use the term neurons to indicate artificial neurons. We will also use the term neuron and the term “processing element” interchangeably. In multi-layer ANNs, processing elements receive inputs (also known as projections) from other processing elements in previous layers. The input image is typically the source for the 1^{st} layer of processing elements. Projections include synaptical weights. Projections from a layer to another layer is typically referred to as an afferent projection. Projections from processing elements in the same layer are typically called lateral projection. The weights values of a projection may be pre-calculated or determined using optimization and machine learning techniques. Without any loss of generality, we will call such optimization techniques simply “machine learning” techniques. Some processing elements may have outputs that represent the outputs of the network, representing classes (or categories or labels) of the patterns being recognized/classified. Outputs can simply represent features that have been derived from the projection (i.e. weighted inputs, synaptical connections, etc. . . . ) computation. When the outputs represent features, they may then be used as inputs to other processing elements, or other modules that may themselves be trained using machine learning techniques to classify patterns presented at their inputs.

Note that in the context of recognizing patterns in sequence of images (e.g. moving pictures, videos), the inputs to the network may be represented by one or more sequences of images, and the outputs of the network may represent either features or classes of patterns that many appear in the inputs. For example, the pattern in the still- and sequence cases may be one or more objects (e.g. humans or part of a human) expressing different types of emotions, facial, or body gestures.

Localization of patterns in a single or multi-dimensional signal is an important step in pattern recognition, and itself may be the pattern recognition objective. For example, the detection of faces in an image is an example of pattern localization. The detection of faces may face significant challenges, for example when the face is partially rotated, obstructed, cut at edge of image, etc. . . . . Hence if one sets the bar too high to accept that a pattern in an image is a face, then some faces may be missed (false negatives). If the bar is set too low, then many patterns in an image may be mistakenly taken as faces (false positives).

The approaches described in this BACKGROUND section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

For a more complete understanding of the present invention, and for further details and advantages thereof, reference is now made to the following drawings and descriptions thereof.

FIG. 1 shows main steps of an object recognition method that uses a digital image as input and that includes aspects of the present invention.

FIG. 2 illustrates the step for producing image enhancements from an input image that yields enhanced images.

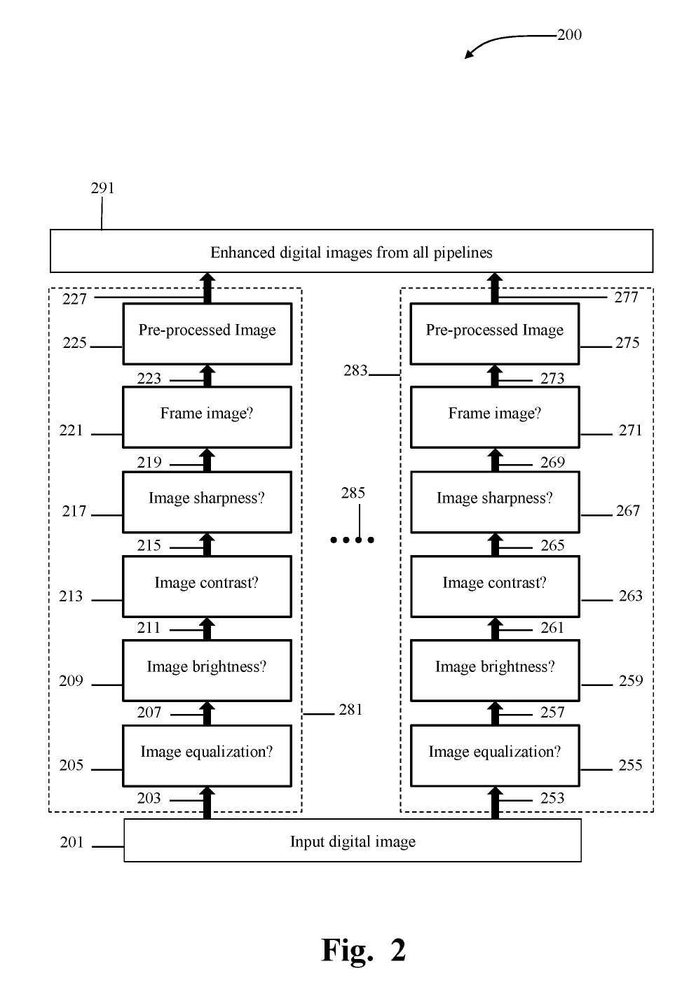

FIG. 3 illustrates an embodiment for the reliable detection and recognition of facial emotion expressions, and that includes aspects of the present invention.

FIG. 4 illustrates an embodiment for producing multiple enhanced images from a digital input image.

FIG. 5 illustrates a multi-layer ANN for feature analysis and producing features.

FIG. 6 illustrates a layer of an ANN that comprises sheets of processing elements.

FIG. 7 illustrates the projections to a processing element from processing elements in another sheet, and from its neighbouring processing elements.

FIG. 8 illustrates a multi-layer neural network features analyser with temporal processing capabilities including traces, projections from traces, and feedback, and that includes aspects of the present invention.

FIG. 9 illustrates a trace of a layer and the topographic aligned projections from processing elements in the layer, processing elements in the layer's traces, as well the lateral projections of surrounding processing elements, to a processing element in the next layer, and that includes aspects of the present invention.

FIG. 10 illustrates feedback to a processing element in a layer from its trace of activities in previous time steps, the topographic projections from elements of its trace at previous time steps, as well the lateral projections of surrounding processing elements, and that includes aspects of the present invention.

FIG. 11 illustrates top-down modulation of activities of processing elements in an artificial neural sheet using errors from a classifier.

FIG. 12 illustrates a biologically-inspired visual feature analysis architecture, and that includes aspects of the present invention.

FIG. 13 illustrates a biologically-inspired visual feature analysis apparatus showing neural sheets of processing elements in layers and their projections, and that includes aspects of the present invention.

FIG. 14 illustrates the topographic projections from two V1S sheets to a target V1C sheet processing element, and that includes aspects of the present invention.

FIG. 15 illustrates the topographic projections from a group of V1C sheets to a V4I sheet processing element, and that includes aspects of the present invention.

FIG. 16 Illustrates an apparatus for feature analysis that comprises top-down modulation, and that includes aspects of the present invention.

FIG. 17 Illustrates embodiment for the recognition of objects in images or sequence of images, and that includes aspects of the present invention.

FIG. 18 Illustrates an apparatus for feature analysis of images or sequences of images, including spatio-temporal feature analysis and top-down modulation, and that includes aspects of the present invention.

FIG. 19 Illustrates embodiment of recognising objects in images or sequence of images, including assigning face owners, detecting and correcting misclassifications, and that includes aspects of the present invention.

FIG. 20 illustrates a block diagram showing various modules of a processing system for detecting and recognizing objects in one or more images, in accordance with certain embodiments.

### DETAILED DESCRIPTION

### Overview

According to the invention, methods and apparatus are provided for reliable object recognition in images and sequences of images by using enhancements of the input digital image, detecting objects in the enhanced images using a detector that can determine locations of potential objects, consolidation of detected object locations using heuristics, validating an object by the means of object/non-object classification regardless of object category, and recognising using the input image and the location of validated detected object to determine the category or the most probable category of the object. For sequence of images, further assignment of a detected object to an owner entity, removal of spurious and redundant detected object locations, and detecting and correcting object categories misclassifications, yielding reliable detection, classification, and detecting and correcting misclassifications of objects in sequences of images. Merely by way of example, the invention is applied to facial emotion expression recognition in images and sequences of images, but it would be recognized that the invention has much broader range of applicability, as explained herein and hereinafter referred to facial emotion expression recognition. The invention applied to the recognition of facial emotion expressions, whether full facial or partial facial, or both, has vast areas of applications. One example application is in the area of human machine interfaces in appliances/equipment including automatic teller machines, dispensing and vending machines, TVs, fridges, social robots, marketing robots, service robots, virtual reality devices and systems, and augmented reality devices and systems. Note, methods and apparatus of the invention can be used to reliably detect and recognize full faces or partial faces (e.g. eyes area, nose areas, mouth area, combinations of these areas) in pictures and in images captured by camera or charge-coupled devices (CCD) devices mounted and/or integrated on cameras, TV screens, computer monitors, smartphones, glasses, virtual reality devices, augmented reality devices and systems, and internet of things devices, and embedded systems. The method of the invention can be integrated on a CCD embedded system, a CCD chip, surface-mount device, or run on a processor (general purpose processor, field programmable gate array based processor, graphic processing units, etc. . . . ) coupled to a CCD device. The integration with CCD on same chip, or mounted together on the same surface, may provide more efficient access to an image or sequence of images. The invention can also be embodied to run on one or more physical or virtual processors in the cloud for use by services and applications, including the applications just mentioned. Images and/or sequence of images from capture devices and embedded systems, or recordings of such images and sequence of images (in compressed or uncompressed forms such as JPEG, MPEG), can be transmitted through a network (wired or wireless) to a cloud service that uses the invention to reliably detect and recognize facial expressions (full facial, partial facial or both). A vast number of applications and services can use such a cloud-based facial expression recognition in images and/or sequence of images, including detection and analysis of crown reactions, conference attendee reactions, supermarket customer reaction, sports game attendee reaction, traveler reaction in venues such as airports, train and bus stations, cinema attendee reaction, remote learning student reaction, class room student reaction, game player reaction, smartphone app user reaction, desktop computer reaction, TV viewer reaction, etc. . . . .

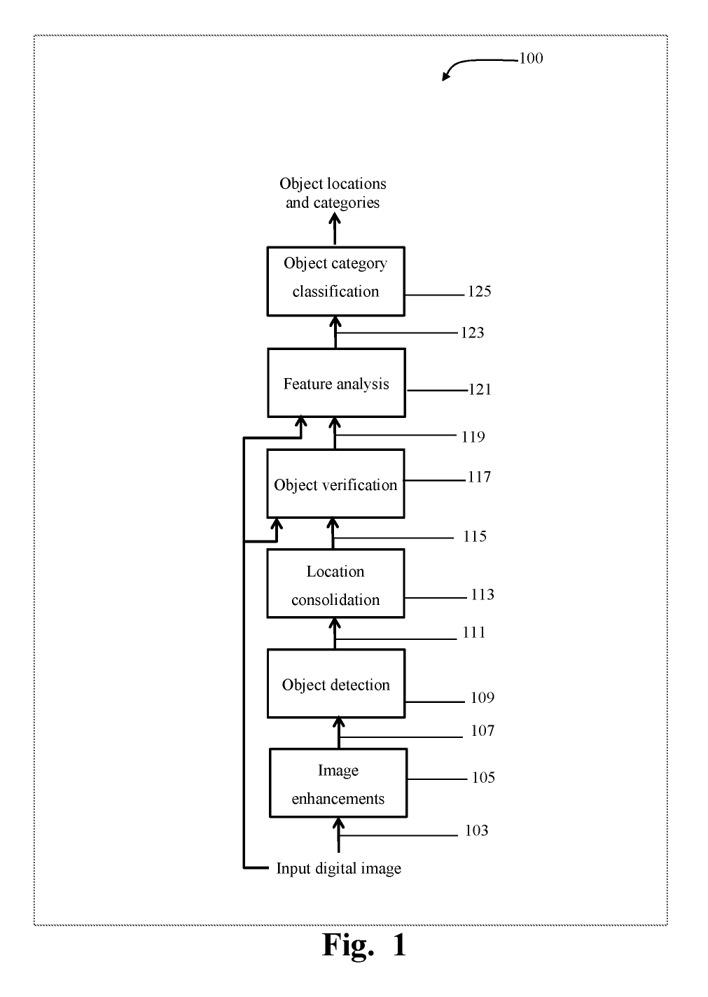

The image enhancements step (FIG. 1 (105)) comprises one or more pipeline of digital image processing operations, relatively inexpensive to implement, but that can significantly enhance the detection of objects in images. The one or more pipeline of enhancements may yield multiple pre-processed images which can then be used as input for object detection. Examples of image processing operations include image histogram equalization, image brightness increase and/or decrease, image sharpness increase and/or decrease, image contrast increase and/or decrease, and/or the addition of a frame of pixels of a pre-defined colour and width around an image. Note the image processing operations in each pipeline need not all be applied. The number of pipelines may also be varied, each implementing image processing operations. Within a pipeline, the processing operations are done in series, and the order may be varied. Object detection is performed on each of image produced by an enhancements pipeline, and all the detected locations in all enhancement images of all the pipelines are considered for further processing.

The object detection step (FIG. 1 (109)) is performed on one or more images produced by the enhancements step, and all the locations are consolidated in a heuristics-based consolidation step. The object detection may use an algorithm like a Haar classifier, or it may use a scanning object detector that may scan an image scaled to a specified number of scales. An important consideration is the detector whether the detection bar is low (more false positives) or not. The object detector may output the boundaries of a potential object detected in an image. The boundaries may be the coordinate of an enclosing rectangle, or may have other geometric shapes.

The detection step is followed by a consolidation step (FIG. 1. (113)), where the locations of objects are kept, merged, or eliminated, according to one or more heuristics. An example of such heuristics is, if one location boundary is enclosed in other location boundary, the enclosing location may be kept and the enclosed one is removed from the list. Another example of such heuristics is, if the location boundaries overlap, and if the overlap exceeds a pre-calculated threshold then the large boundary is kept, and the smaller one is removed from the list. These consolidation heuristics may be repeated until consolidation results in no change, and the resulting consolidated object location boundaries are then considered for further processing.

The consolidated object boundary locations are then used, together with the input digital image for object verification, regardless of the category of the object. The object verification step (FIG. 1. (117)) comprises the use of an object/non-object classification step implemented using an artificial neural network that is trained to perform object/not-object classification. The object/non-object classification is used to eliminate any spurious patterns and false positives that may have been detected by the object detector. As a result of this verification step only location boundaries of verified objects are kept. The location boundaries of verified objects and the digital input image are then used to classify the category of verified detected objects using feature analysis (FIG. 1. (121)) and object category classification (FIG. 1. (125)), yielding a category and/or a probable category, for each of these objects. Steps (121) and (125) can be jointly implemented using an artificial neural network (e.g. a convolutional neural network) that is trained on images of object categories. These two steps may also be implemented separately, (121) using a parametric model-based feature analysis, and the classifier (121) (support vector machines type classifier) trained on the features produced by the feature analyser in response to images of object categories.

In the case of a sequence of images the (FIG. 1. (100)) steps described above can be iterated for each image in the sequence. Further steps to improve the reliability and quality of detection and recognition in sequences of images are described further below.

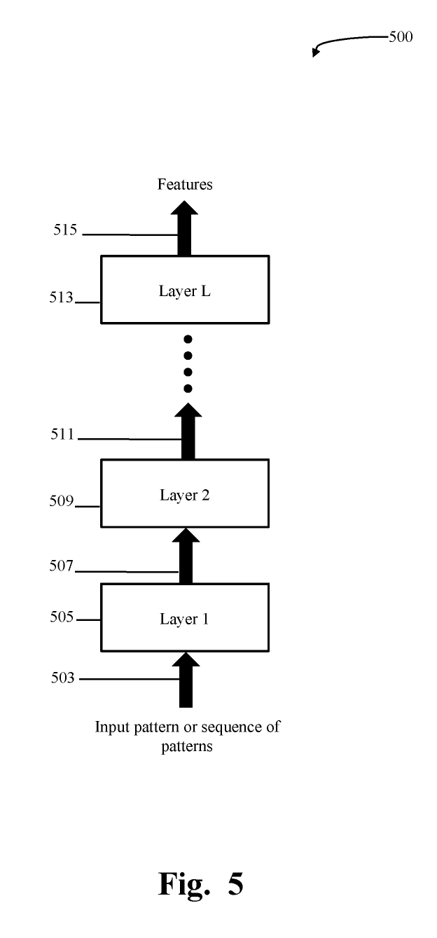

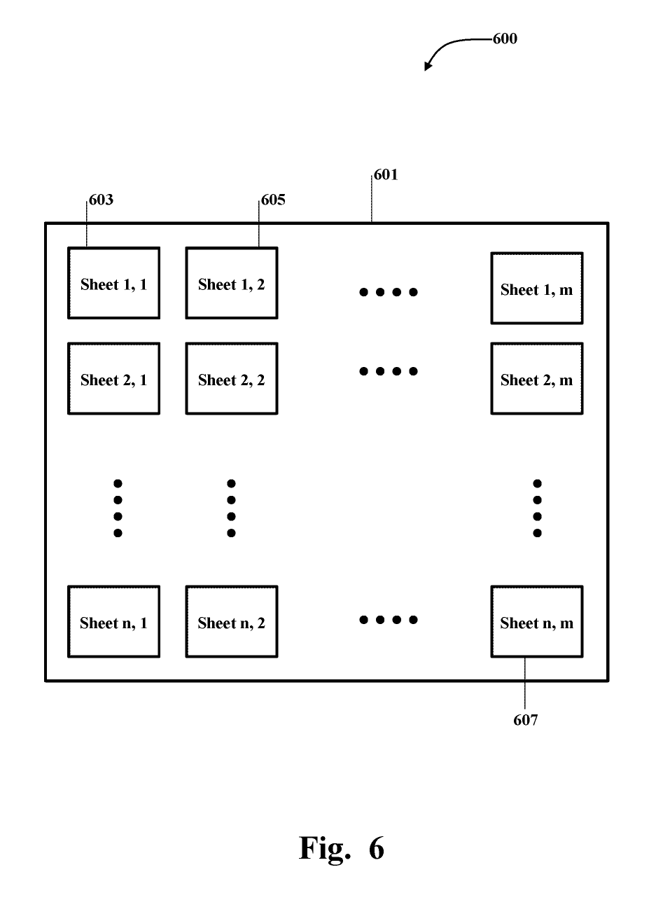

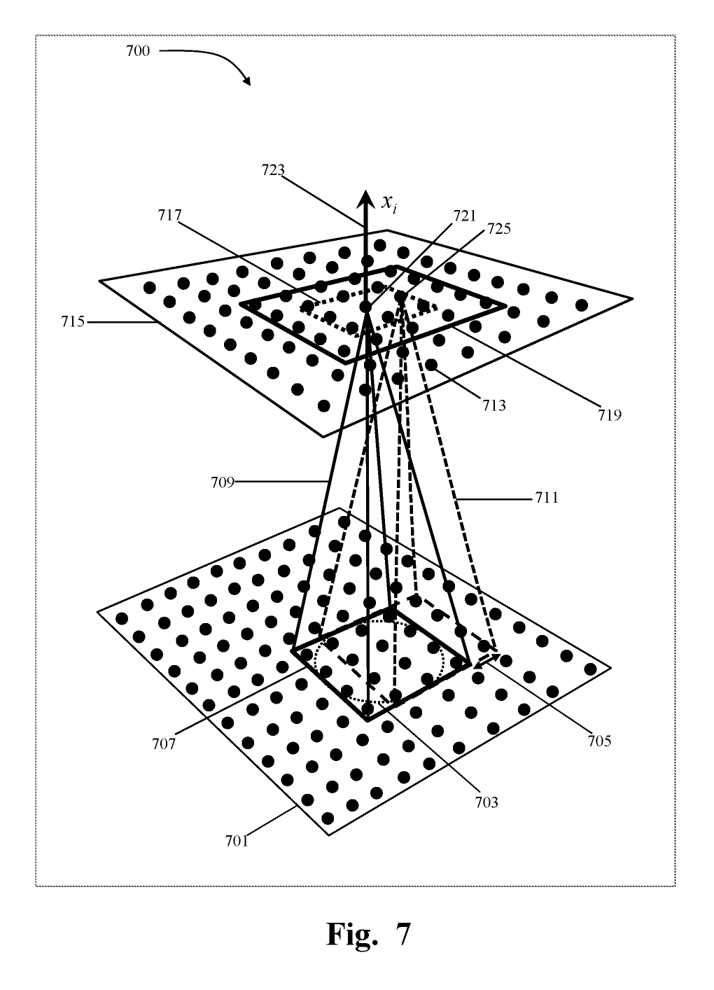

Note that the feature analysis step can be implemented using a biologically-inspired neural network method that is trained using unsupervised learning technique. This architecture is inspired by what is known of the primate visual system, namely areas labelled by neuroscientists as V1, V4, and PIT (posterior inferotemporal) and AIT (inferior inferotemporal) cortices. This feature analysis step is illustrated in FIG. 5 (500), where the input is a digital image or a sequence of digital images, and the outputs are features represented by one or more arrays representing outcome of the feature analysis of this step. The feature analysis is about extracting and/or deriving features that represent information in the image pertinent to the subsequent classification. An advantage of this feature analysis, compared to that using an artificial neural network trained using supervised learning methods, is that much less data is required to train the architecture to perform a desired feature analysis. Each layer in this feature analysis architecture comprises neural sheets (arrays of processing elements). Unless specified otherwise, and without any loss of generality, a sheet will refer to a two-dimensional sheet of processing elements. Sheets can be stacked vertically or spread horizontally, and may be topographically aligned. A layer of FIG. 5 (500), e.g. FIG. 500 (505), comprises a matrix of sheets as illustrated in FIG. 6 (600). The matrix may have one or more elements, that are all topographically aligned. So, for example, sheet FIG. 6 (603) and sheet FIG. 6 (607) are topographically aligned and their processing elements generally correspond to similar location in the input image. We indicate “generally” as the sheets many not have same dimensions and their topographic alignment may be quantized differently with respect to the dimension of the input image. A processing element in a sheet (FIG. 7 (721)) receive weighted input connections from processing elements in other sheets (FIG. 7 (701)) in different layer (all sheets are topographically aligned) or from processing elements surrounding them in the same sheet (processing elements enclosed by (717) and (719) in FIG. 7. We call these weighted inputs connections “projections”. Therefore, a projection indicates the weighted connections of a group of processing elements to a processing element, and in the context of a topographic aligned projections, the group is defined by a receptive field defined by a geometric shape which may relate to an angular extent of a visual field on the input image. The weights in connections or projections are analogic to synaptical connection strengths, and may be set initially to pre-calculated values and further changed by a learning algorithm. A receptive field (RF) is defined by the extent of the subset of processing elements (e.g. FIG. 7 (707)) projecting to a processing element (FIG. 7 (721)). The RF can have any shape. Rectangular RF shape is illustrated in (e.g. FIG. 7 (707)), and a circular one in (e.g. FIG. 7 (703)). A neighbouring processing element (FIG. 7 (725)) may receive a projection from the same RF, or as shown in FIG. 7 (711) from an RF that has been shifted by the stride as illustrated in FIG. 7 (705). In signal processing image convolution analogy, the stride would be typically 1. In the approach presented here, the stride is not necessarily constant, and may vary from a sheet to another, from a layer to another, and is typically controlled by a number of factors, including the dimension and neural densities of the transmitting sheet (FIG. 7 (701)) and receiving sheet (FIG. 7 (715)). The projections to a processing element (e.g. FIG. 7 (721)) from its surrounds (i.e. processing elements enclosed within (717) and (719) in FIG. 7) are called lateral projections and can be antagonistic, meaning, they could have opposite signs. For example, and without any loss of generality, if one projection weights have a positive Gaussian shape and the other has a negative Gaussian shape, then the resulting combined projection will have the shape of a Difference of Gaussians (DoG). When the stride between the RFs of two projections to neighbouring processing elements in a receiving sheet is 0, then the projections are including weighted inputs from the same processing elements in the transmitting sheet, even though the weights of these RFs may be different, and may evolve differently during learning, mainly due to the antagonistic lateral projections. Therefore, the processing elements that are receiving input from the same processing elements may develop different feature tuning capabilities, meaning their responses will become tuned to the patterns in their RFs. Furthermore, as in object recognition the level of details may be more important in some parts of an object than other parts, the stride can be used to control the number of processing elements that are attending to the same location on the object, providing thus more allocation of the processing elements which are effectively extracting the feature, to some specific areas in the visual field. We call this multiplicity control, and it can be controlled by manual design, or programmatically before learning is initiated, or even during learning, as to recruit and/or allocate more processing elements with afferent projections from a specific area of the visual field.

The feature analysis method can be further extended and equipped with spatio-temporal feature analysis capabilities that are highly beneficial for the handling of sequences of patterns, including sequences of image. The spatio-temporal capabilities extend the analysis as features extracted by the various layers for a specific input image of the sequence may be used in the analysis of a later input image.

The feature analysis method, with or without spatio-temporal capabilities, can be extended further to include top-down modulation (TDM) to modulate the bottom-up input-image-driven activities of processing elements by a top-down signal. Forms of TDMs are known to exist in the primate brain and believed to play an important role in shaping the activities of other cortical areas. The shaping could aim, for example, at inhibiting some neural population as to encourage others, on the basis of some top-down expectation or outcome computed by some cortical areas, yielding better feature representations, and hence better learning and decisions in other cortical areas. The feature analysis TDM step permits the modulation of one or more sheet in a layer by the means of applying a modulation signal to the activity of processing elements. The TDM signal may be derived from a mapping of the sheet's processing elements activities. The mapping may as an example utilise back-propagated errors of a multi-layer perceptron that is trained to classify the image using as input the activities of one or more sheets.

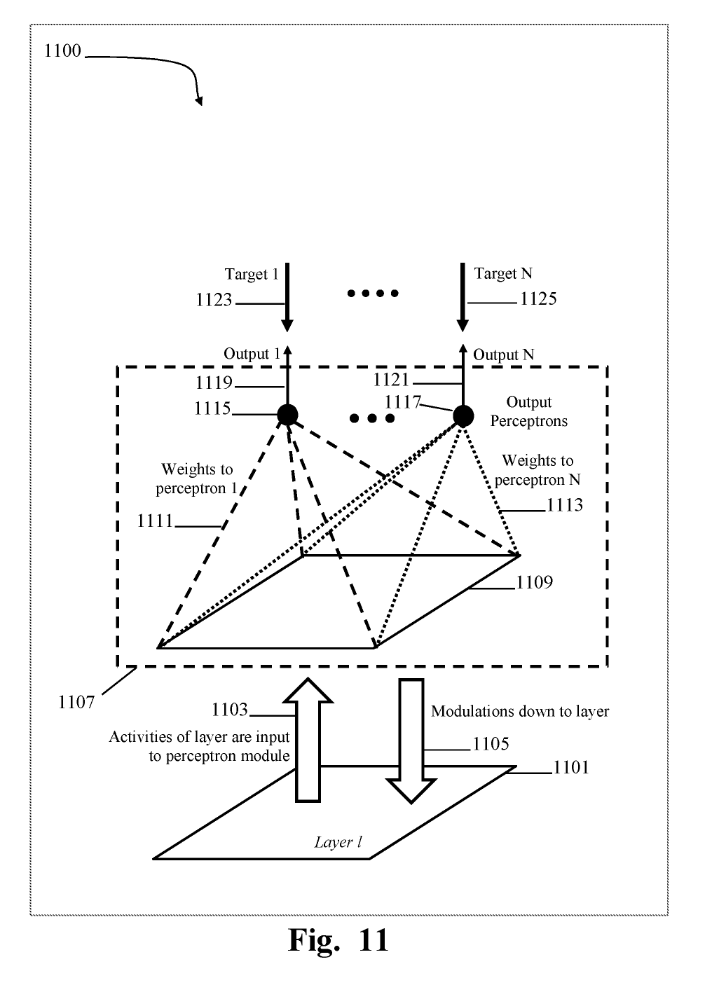

The TDM operation is illustrated in FIG. 11 (1100) which shows the TDM of a feature analysis layer. The TDM signals are provided by a step that uses as input the instantaneous activities of layer l (FIG. 11 (1103)) as input to an artificial neural network (FIG. 11 (1107)) that can map these activities to some output (e.g. output 1 to N; elements (1119) and (1121) as examples). The TDM signals generation step also receive the targets for these outputs (e.g. FIG. 11, (1123), (1125)), where such targets may originate from labelled data, or real-time input from other modules or systems. Using the actual outputs and the targets, the TDM signals are computed from the errors (e.g. mean squared errors, soft-max, etc. . . . ) to derive the signals (FIG. 11 (1105)) that can be used to modulate the instantaneous activities of layer l. Note the errors can be propagated back in the artificial neural networks (through the processing elements and the weights), in a similar way to back propagation in the multi-layer perceptron back-propagation algorithm. The ANN we have illustrated in FIG. 11 (1107) has one layer of perceptrons, but clearly the same technique can be used with any type of neural network architecture that can back-propagate errors, and then derive from the errors the top-down modulation signals.

The TDM signals can be used as a gain factor in the instantaneous update of the activities of the processing elements of layer l, for example and without any loss of generality, resulting in elements being more or less inhibited. This has the effect of a top-down gain control for these processing elements, encouraging some to be more tuned to some of the inputs in the RFs than others, and hence enhancing selectivity, sparseness of the activity, and improved feature analysis. TDM ANNs can be pre-trained, and/or continuously trained, and/or trained, and used to in the training or operations of feature analysis methods.

Particular embodiments of the invention include a machine-implemented method (100) of recognizing a category of a set of categories of at least one object in at least one digital image, the method comprising accepting at least one image into a data-processing machine, and enhancing the at least one digital image to produce one or more enhanced digital images using digital image processing operations that modify at least one of the set of properties consisting of a histogram, a brightness measure, a sharpness measure, and a contrast measure of the at least one digital image. The method also comprises detecting boundaries of the at least one object in the one or more enhanced digital images, and consolidating the detected boundaries of the at least one objects in the one or more enhanced digital images using heuristic methods to remove spurious detections of objects. Also included in this method is determining whether or not each of the at least one detected object is a valid object using a validity classifier. The method also comprises determining a respective category of a set of categories of each respective object determined to be valid of the at least one detected object, the determining of the category using feature analysis, classification, the at least one digital image, and the boundaries of the at least one detected object. This method changes each of the at least one image into at least one category of at least one detected object in each of the at least one image.

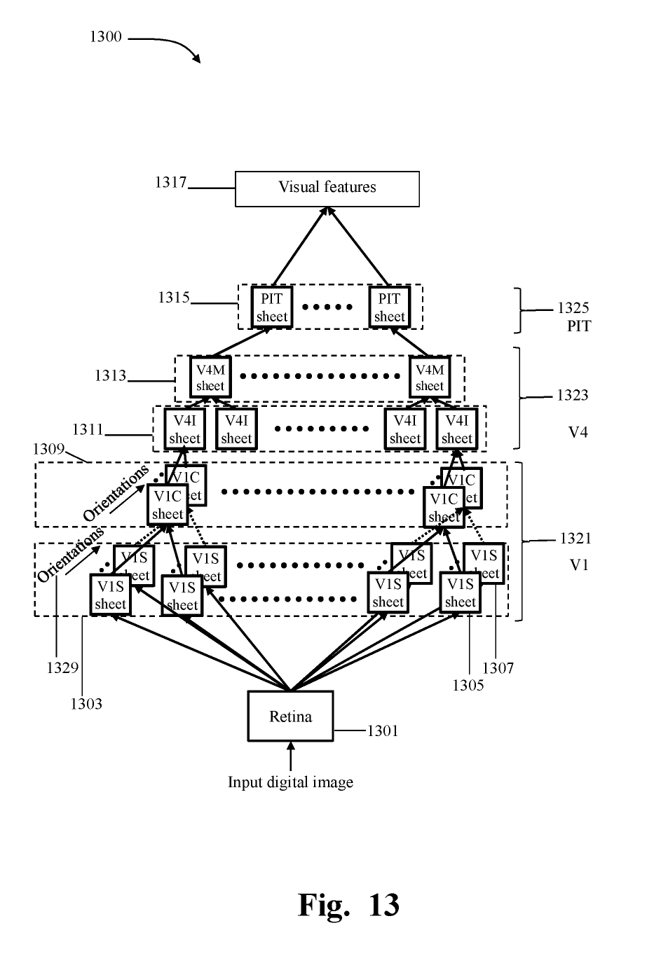

Particular embodiments of the invention include an apparatus (FIG. 13 (1300)) for calculating features of a digital image, the apparatus comprising a retina module (1301) operative to receive an input digital image and to scale the dimensions and the values of the pixels of the input image. The apparatus (1300) also includes a V1 module (1321) that comprises a V1 S layer and a V1C layer that comprise processing elements that are coupled to the retina module. Also included in the apparatus (1300) is a V4 module (1323) that comprises a V4I layer and a V4M layer, both comprising processing elements that are coupled to V1C module. Also included in apparatus (1300) is a PIT module (1325) comprising processing elements that are coupled to V4M sheets of the V4 module, and where the output of the PIT processing elements are calculated visual features.

Particular embodiments of the invention include a machine-implemented method of detecting and recognizing objects in sequence of digital images, the method comprising accepting a sequence of one or more digital images. This method also includes enhancing the digital images of the sequence to produce one or more enhanced digital images, the enhancing of a digital image comprising using digital image processing operations that modify at least one of the set of properties consisting of a histogram, a brightness measure, a sharpness measure, and a contrast measure of the digital image. This method also comprises detecting boundaries of at least one object in the one or more enhanced digital images, and consolidating the detected boundaries of objects in the one or more enhanced digital images using a heuristic method to remove spurious detections of objects, such that each detected object has an associated location in the image in which it is detected. This method also includes determining whether or not each detected object is a valid object using a validity classifier. This method also comprises determining a respective category of a set of categories of each respective object determined to be valid of each detected object, the determining of the category including applying a category classification using the input image associated with the image in which it is detected and the detected object location. This method is such that it changes one image in sequence of images into at least one category of at least one detected object in said image.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### SOME EXAMPLE EMBODIMENTS

### Embodiment: Method of Recognizing Facial Emotion Expressions in an Image

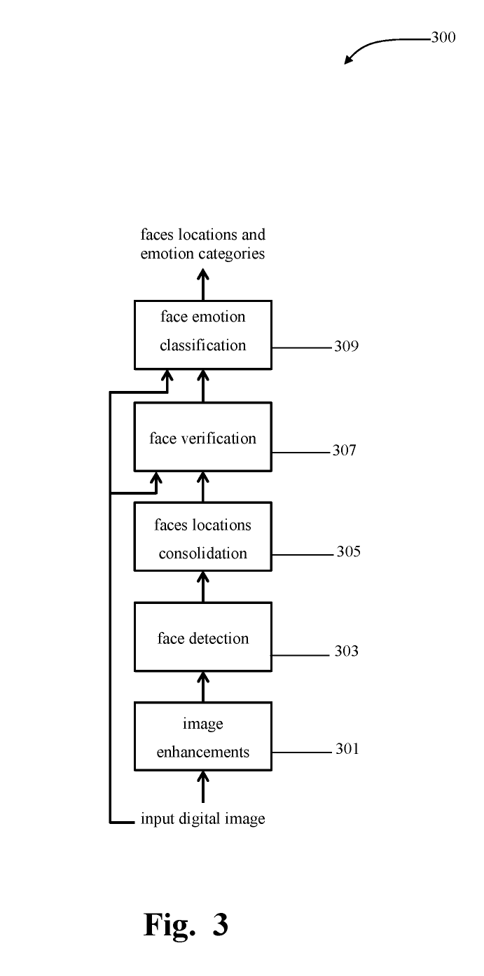

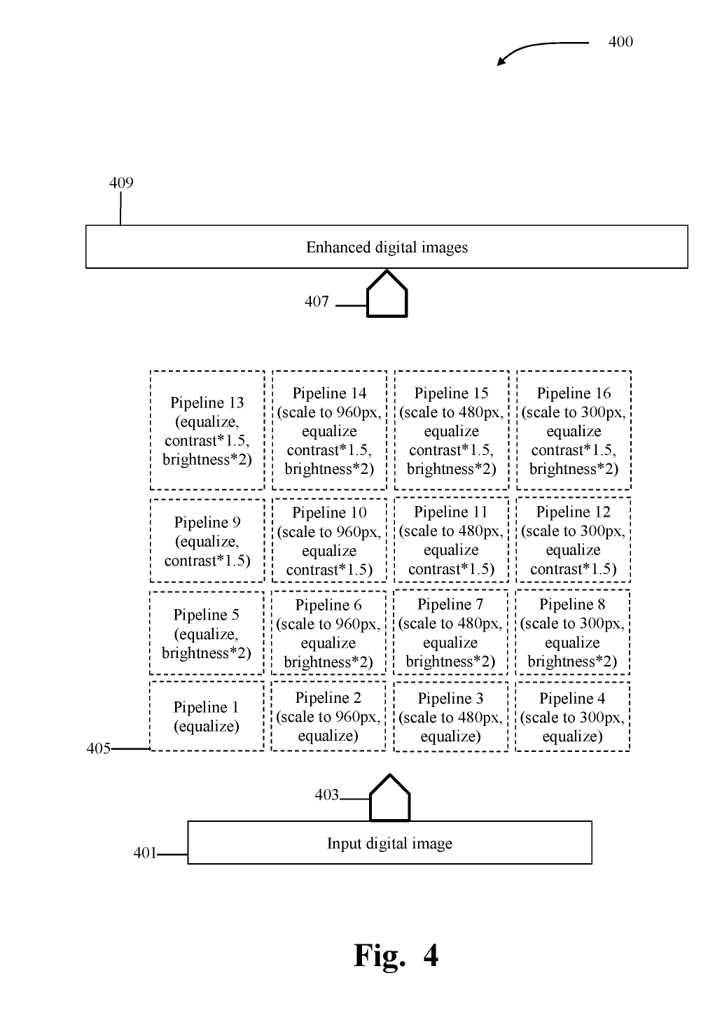

In one embodiment, the method (FIG. 3 (300)) of reliably detecting and recognizing the categories of emotions expressed by full or partial faces, and where the emotion categories include neutral, anger, contempt, disgust, fear, happiness, sadness and surprise emotional expressions. The embodiment comprises an image enhancements step (FIG. 3 (301) that produces image enhancements according to the image operations pipelines illustrated in FIG. 4 (400), and which can produce up to 16 enhanced images. For example, the first enhancements pipeline, Pipeline 1 (FIG. 4(405)), operates on the image unscaled, with unchanged brightness, contrast, sharpness, but equalized, yielding pre-processed Image 1. The second enhancements pipeline, Pipeline 2, scales the image to a maximum size of 960 pixels on its longest side, and repeats the same image operations as of Pipeline 1, yielding pre-processed Image 2. The third pipeline, Pipeline 3, is similar to Pipeline 2, but uses a maximum side of 480 pixels, yield Image 3. Pipeline 4, is similar to Pipeline 2, but uses a maximum side of 300 pixels. Note that a pipeline that requires the scaling of an image to a target maximum (e.g. 960, 480, 300), will only be performed is the image has a side larger than the target maximum. Pipelines 5 to 8 are similar to Pipelines 1 to 4, respectively, but with the brightness factor increased by 100% (i.e. doubled), yielding Images 5 to 8. Pipelines 9-12 are similar to Pipelines 1 to 4, respectively, but with the contrast increased by 50%, yielding images 9 to 12. Pipelines 13 to 16 are similar to Pipelines 1 to 4, respectively, but with the brightness and contrast increased by 100% and 50% respectively, yielding Images 13 to 16. Hence a total of up to 16 images can be produced by the enhancements step. A face detection step (FIG. 3 (303)) is used to detect all faces or parts of faces. The face detection step uses a detector based on a Haas detector that is trained on a large number of faces (and parts of faces), and non-faces images, and is relatively fast, and operates at multiple image scales. The face detector also detects partial faces, like profile and rotated faces, inclined faces, parts of face (e.g. eyes area) that may only visible whether purposely or not. Hence, and without any loss of generality, the term face refers to full faces and/or partial faces. The output of the detector includes the coordinates of rectangles, each rectangle locating and enclosing a detected face. The enclosure may enclose part of a face. Note the face detection step detects one or more faces in an enhanced image. The detected faces locations in all the enhanced images are then consolidated by a faces location consolidation step (FIG. 3 (305)) where the faces locations are coordinates of rectangles where a rectangle enclose a face. This step merges, removes, and/or keep face location rectangles using heuristics. The heuristics aim at eliminating spuriously detected faces, for example, a face detected inside another face where it is not supposed to be, two faces largely overlapping according to a threshold based on the calculation of a proportion of the smaller rectangle, etc. . . . . The result of the location consolidation step are the remaining coordinates of locations of faces which, and the input digital image, are use as input to a face verification step (FIG. 3 (307)), which classifies each location whether it a face or a non-face. This classifier uses an artificial neural network, with a convolutional neural network style, that is trained using a large amount of face (full or parts) and non-face images dataset, and that achieves a high reliability validation (over 99.998% correct classification on tens of thousands of test cases). This classifier is agnostic to the expression on the face, the face rotation to a large degree, and to significant obstructions that may exist and that render only parts of the faces being visible. The artificial neural network is trained using stochastic gradient descent. The locations of verified faces and the input digital image are used by a face emotion classifier step (FIG. 3 (309)) to classifies the emotion of each verified face. The face emotion classifier uses an artificial neural network trained on a large dataset of facial images expressing emotions comprising: neutral, anger, contempt, disgust, fear, happiness, sadness and surprise emotional expressions. These expressions can be associated with the full face or parts of the faces (e.g. angry eye area). The neural network classifies the image patch (sub-area of image enclosed by the location rectangle of the object) with some pre-calculated padding around (expanding) or shrinking (reducing) of the object enclosing rectangle. Whether expanding or shrinking, we refer to this as padding, with values positive for expansion, and negative for shrinkage. The padding values are pre-determined based on actual values of pixels or percentages of the side of the detect object location enclosure. The padding values used in this embodiment are set to 10%, 10%, 10%, 20% for the left, top, right and bottom, respectively, where the percentage refer to a percentage of the side of the face enclosing rectangle as detected. The output of the face emotion classification step includes the probable category of emotion for each face at a detected location. The probability of each emotion category for each face is also produced.

### Embodiment: Apparatus for Biologically-Inspired Image Feature Analysis

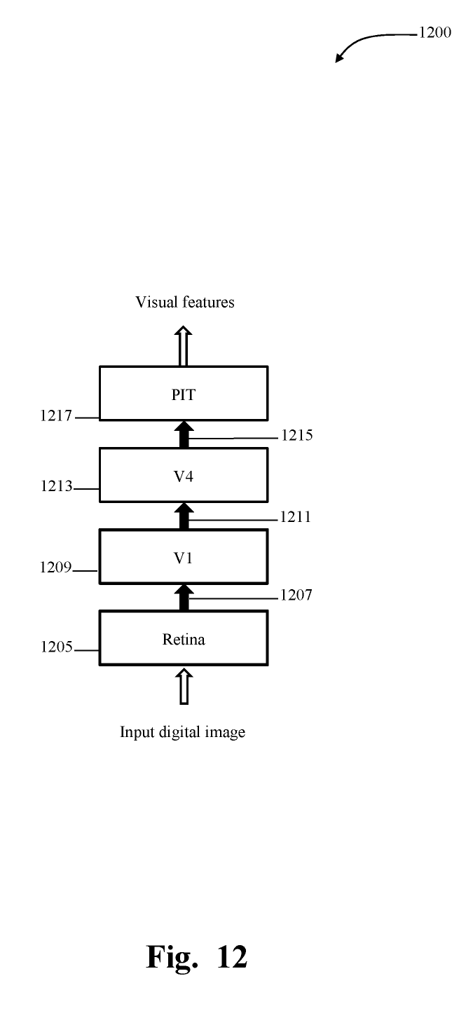

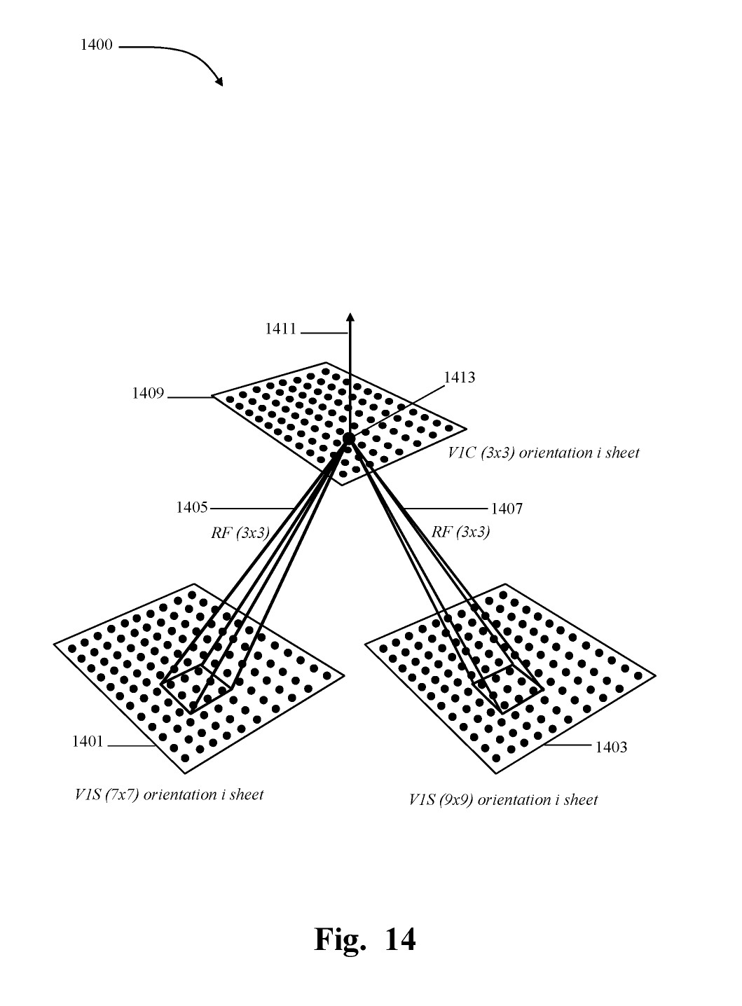

In one embodiment, an apparatus of visual feature analysis of digital images is illustrated in FIG. 12 (1200). The apparatus comprises a Retina module (FIG. 12 (1205)) which receives a digital input image and scales the shape of the image and the values of the pixels to pre-define values, so as the dimensions of the retina output image (1207) and the values of elements of the image meet desired values. For example, and without any loss of generality, the dimensions may be scaled as to fit in a 196×196 window, and the element values of the image (pixel values) may be scaled to fit in a [0,1] interval. The Retina module output, through projections, is received by the V1 module (FIG. 12 (1209) which consists of two sub-layers as illustrated in FIG. 13 (1321). The V1S sublayer has sheets of processing elements that have RFs that are set to predefined Gabor filters along wave length size and orientations. For example, and without any loss of generality, the V1S sheet of FIG. 13 (1305) may be associated with projections from Retina that have weights set to a Gabor wavelength of size 37×37 oriented at 0 degrees, and V1S sheet of FIG. 13 (1307) associated with projections from Retina that have weights of set to Gabor wavelength of size 37×37 at 157.5 degrees. The processing elements of V1S weigh the topographically positioned input path from the Retina using the Gabor defined weights and then apply a transfer function to produce an output activity. The transfer from may be linear or non-linear. The output of V1S sheets are filtered versions of the Retina image using a Gabor filter defined for each of the V1S sheets. The V1C sublayer of V1 module is also organized along orientations as indicated in FIG. 13 (1329), and has a number of sheets as to pool the maximum activities of processing elements of two or more topographically aligned V1S sheets processing elements along an orientation. This is illustrated as an example of a sheet in FIG. 14 (1400) where we illustrate a V1C sheet (1409) pooling the inputs from two V1S sheets (1401) and (1404), through receptive fields. In FIG. 14 we also illustrate the topographic alignment of projections. Note, processing element (1413) receives two projections (1405) and (1407) from V1S sheets associated themselves with RFs of Gabor wavelength sizes 7×7 and 9×9, respectively. In the case illustrated in FIG. 14 (1400) the projections that processing elements of V1C sheet (1409) receive have RF size of 3×3, hence the “3×3” attached to the name of the V1C sheet. As there are several orientations, the orientation is also attached to the name of the V1C sheet for clarity.

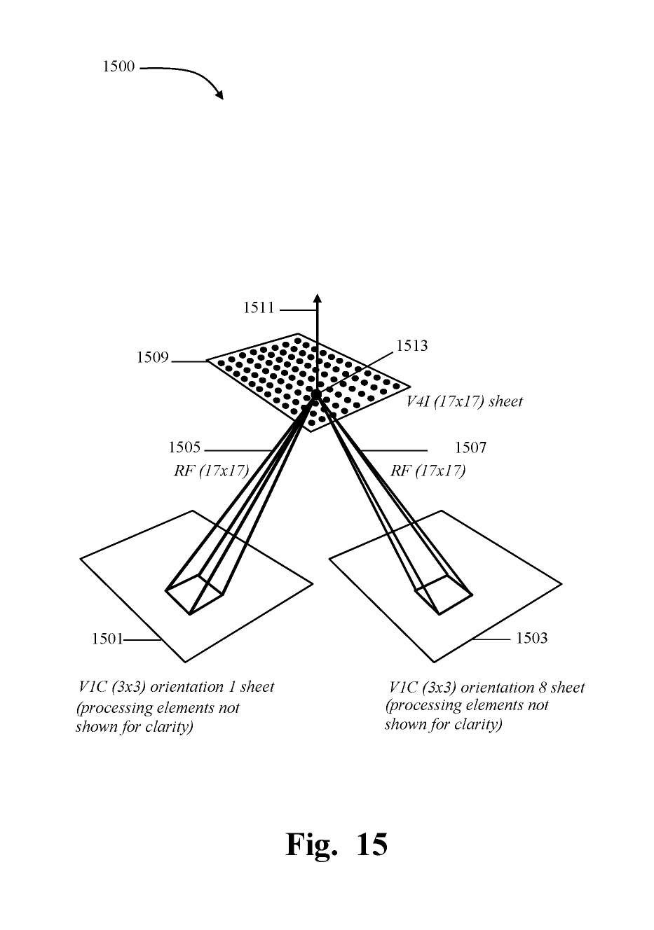

The output of V1C are the output of the V1 module, that the V4 module (FIG. 12 (1213) receive. Each V1C group (all orientations) sheets project jointly and in a topographic aligned fashion to a sheet in the input layer of module V4, V4I (FIG. 13 (1311)). Hence the V4I sheets (FIG. 13 (1311) integrate the orientation activities of V1C bands while being tuned, through Hebbian learning, to complex visual features that the V1C processing elements are representing. The V4I sheets receive the projections from V1C through receptive fields (RF) of size that are pre-defined (e.g. 17×17). These are the afferent inputs of V4I. The V4I sheets also feature lateral excitatory and inhibitory projections. Afferent and lateral excitatory and inhibitory projections are illustrated in FIG. 7 for a processing element (721) as an example. V4I has same type of projections as (715) of FIG. 7 and as per the figure, V1C sheets play the role of the (701) of FIG. 7. We illustrate an example of projections of V1 to V4 (V1C to V4I) in FIG. 15 (1500), where a processing element of a sheet of V4I (FIG. 15 (1509) is receiving two projections from processing elements in sheets (1501) and (1503) in FIG. 15 (other sheets of the orientations are not shown). Note FIG. 15 does not show the lateral projections in V4I for simplicity.

Also note all V4 RFs are topographically aligned, except when “cortical magnification” (RF multiplicity) is used, in which case the RFs positions from the source sheets are re-mapped according to a coordinate mapping function which make the target sheet over-represent a specific source area. This is analogical to cortical magnification of observed in primate visual pathways allowing. In our apparatus, V4I has cortical magnification as a parameter and allows more processing elements in the V4I sheets to receive projections from the same topographic locations in V1C. Although the location of the source is the same, learning (e.g. Hebbian learning) makes these RFs develop different tunings as a result of the presence of lateral projections and different initial settings for the RF weights. As a result, different feature filters develop for the same topographic location in the visual field of V4I processing elements. The V4I sheets are grouped, and each group projects jointly to an output sheet in layer V4M (FIG. 13 (1313)) of V4. A V4M sheet has processing elements that perform a pooling (e.g. max function) of its V4I group input activities. The output of the V4M sheets represent the output of module V4.

The module PIT (FIG. 13 (1325)) receives the output of V4 (the V4M outputs), and comprises a layer that comprises sheets that receive projections from groups of V4M sheets of V4. The PIT sheets (FIG. 13 (1315)) have similar structure to V4I sheets, through their key architectural parameters (e.g. density, RF sizes, cortical magnification, etc.) may differ. The PIT sheets processing elements, through learning (e.g. Hebbian learning), develop higher order visual feature tunings that combines feature tunings of V4. If V4 processing elements become tuned to become responsive to the presence of “parts” of objects in the input image, then PIT processing elements become responsive (through learning) to a group of “parts”. The extend of the parts depend on the extents of the receptive field from V1S all the way to those of PIT.

The receptive field sizes used in the apparatus are derived from the receptive fields values observed for biological neurons in the primate cortex.

The outputs of the PIT sheets (FIG. 13 (1315)) represent the output of the apparatus, and are maps (e.g. images) of activities representing present of visual features in response to an input image.

Note the receptive fields of V4I and PIT can be initialized to random Gaussian values. At that point, the visual feature extraction is impressive and can be used as input to recognition systems. Additional tuning of the receptive fields via Hebbian learning further improve the quality of the tuning. Hence such apparatus could also be very advantageous to situations where data for learning is scare, or for life-long learning by setting the learning rate to be small.

We will use the illustration in FIG. 7 to describe a machine learning procedure to determine the values of the synaptical weights of projections. Consider the processing element i labelled (721) in FIG. 7. The projections synaptical weights feeding into processing element i from sheet (701) via projection (709) and the lateral excitatory (717) and inhibitory (719) projections within this sheet form the total weights into this processing element.

Let us define

netᵢ=rΣ_{jεR}_{ₓᵢ}xⱼwᵢⱼ

the net input to processing element i the is sum of the weighted inputs from Rₓᵢ, the set of all processing elements feeding into processing element i, including lateral ones, and where r is the projection strength factor which is a configuration parameter for the projection. The output of processing element i, xᵢ, is

xᵢ=f(netᵢ)

where f is the processing element transfer function (e.g. linear, piecewise linear, normalizing, etc.). Because of the lateral inhibition and excitation, the processing elements require several iterations for their output to settle. The number of iteration (aka number iteration to settle) is typically set to 4 but may be varied like 2, 3, etc. . . . .

All the weights of the processing elements may be initially set as random values and then adapted using Hebbian learning according to

wᵢⱼ=xᵢⱼ+ηxᵢxⱼ

where η is a constant learning, typically a small fraction of 1.0. Note all the weights are updated, including the lateral connection weights. In order to avoid the possibility of the weights growing infinitely, the weights are normalized after the updates are done according to

$${w}_{ij} = \frac{{w}_{ij}}{{W}_{i}}$$

where Wᵢ=Σᵢ wᵢⱼ is the normalization factor. Note index j iterates over all weights into processing element i, including the lateral weights, and the learning rate may be adapted using a decay factor.

Some interesting aspects of the architecture and learning can be noted here. The processing element density of a receiving sheet may be higher or lower than that of the projecting sheet. If the density is high enough, then multiple adjacent processing elements in the receiving sheet may have a receptive field on the same patch in the transmitting sheet, but with a different set of synaptical weights that develop as result of learning. This is mainly due to the lateral projections of the processing elements in the receiving sheet. It permits distinct tunings to develop for the same spatial location in the projecting sheet, and hence for a relative position in the visual field. This is consequential as it allows the learning of different feature filters within and across images of same or different objects in the visual field (space scale) or of same image at a different time (time scale). We also call this a multiplicity of representation as it allows richer capture of spatial visual features. If the multiplicity did not exist, that is only one processing element in the receiving sheet is associated with a patch in the projecting sheet, then different visual spatial features will be merged to a point that losing the diversity of feature filters.

### Embodiment: Apparatus for Feature Analysis with Top-Down Modulation

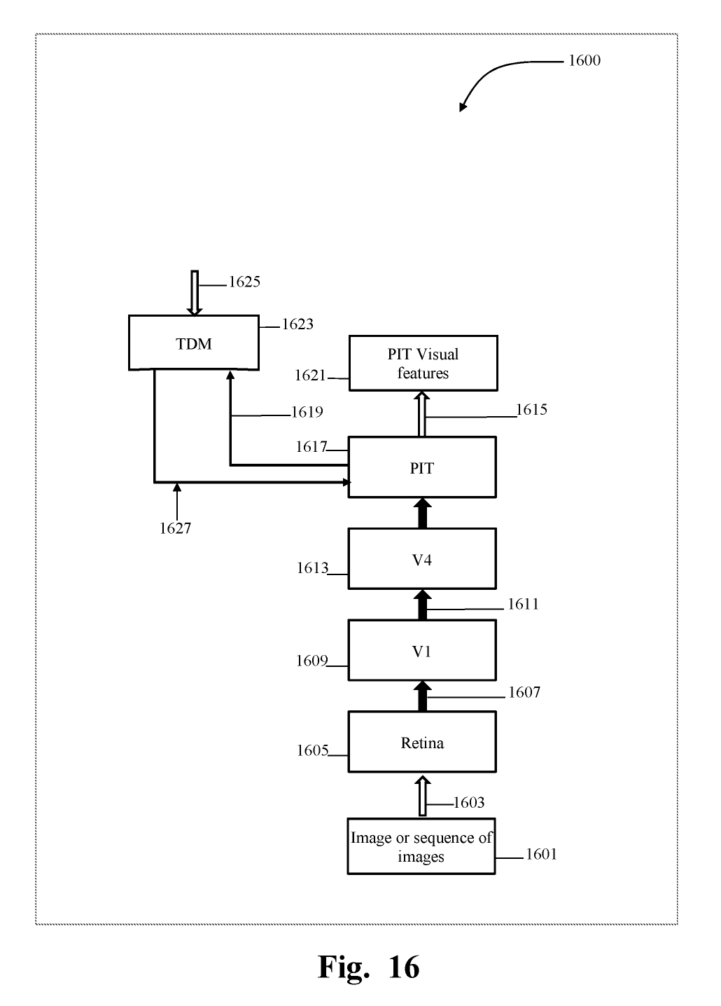

In an embodiment, the apparatus of FIG. 16. (1600) where the apparatus of FIG. 12 (1200) is augmented to comprise a TDM module (FIG. 16 (1623)) that can be used during feature analysis learning, learning and operation, or operation modes.

The TDM module (FIG. 16 (1623)) uses the method illustrated in FIG. 11 (1100) and modulates the activities of the layers of the PIT module (FIG. 16 (1617)) via the output signals it produces (FIG. 16 (1627)). The input to the module comprises the instantaneous activities (FIG. 16 (1619)) of the processing elements in sheets of the PIT layer, and the target categories (classes) associated with the input to the apparatus (FIG. 16. (1625)). The output of the module is derived from the back propagated errors in response to the inputs to a multi-layer perceptron in the module. The classes (categories) are the target classes associated with the input image to the apparatus. The back-propagation algorithm is used to derive errors and then back-propagate theses errors to the inputs of the multilayer perceptron in module FIG. 16 (1623) and then then modulation signals are derived according to:

mᵢⱼ=M·(1−eᵢⱼ)

Where M is a modulation rate (a small fraction of 1.0) and eᵢⱼ is the normalized multi-layer perceptron back-propagated error at position (i, j) in the two-dimensional input to the perceptron. Note as the activities feeding into each perceptron are weighted, the back-propagated error are weighted as per the back-propagation algorithm.

The TDM signal application can be optionally configured to operate stochastically, by making the application of the modulation signal to a processing element in PIT layer conditional on a random process. For example, and without any loss of generality, a random number could be generated and if the number is smaller than the error at the processing element position in the sheet, then the modulation signal is set to 0 for that processing element (effect of totally inhibiting the processing element), otherwise it is simply set to the modulation signal value at this position. Therefore, in this case, the larger the error at a processing element position (i, j) in a sheet of PIT layer, the more likely the processing element activity will be inhibited (multiplied by 0.0), and when learning in ongoing using the Hebbian learning for the RF of this processing element, no weights will be changed as the processing element activity is inhibited to 0.0.

### Embodiment: Apparatus for Spatio-Temporal Feature Analysis

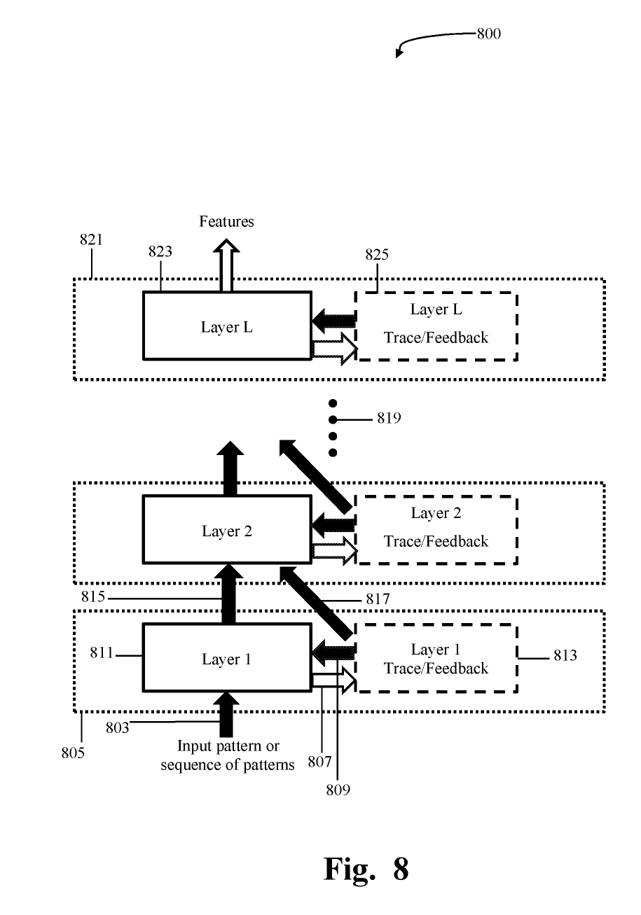

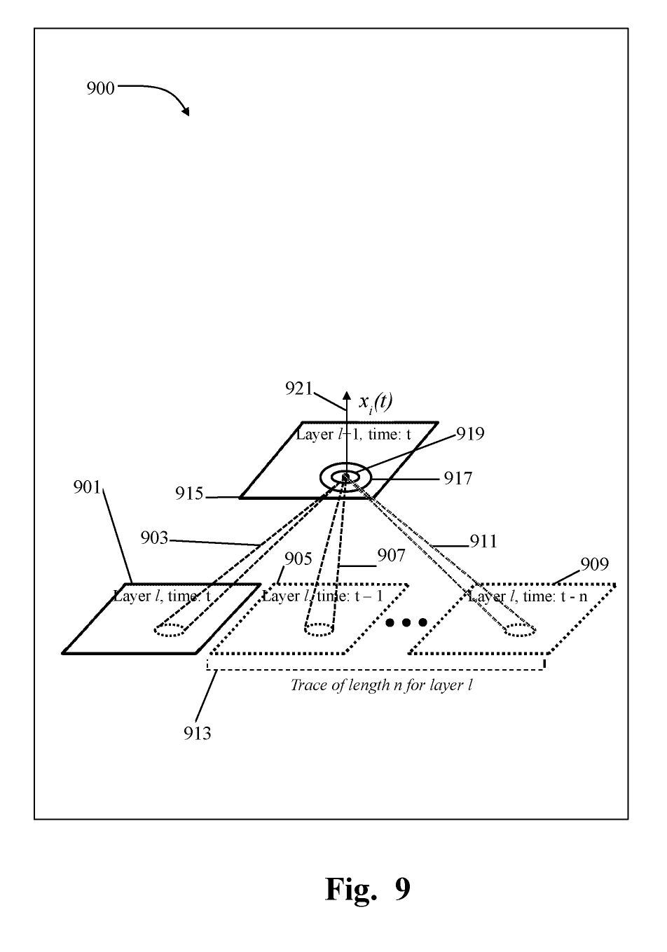

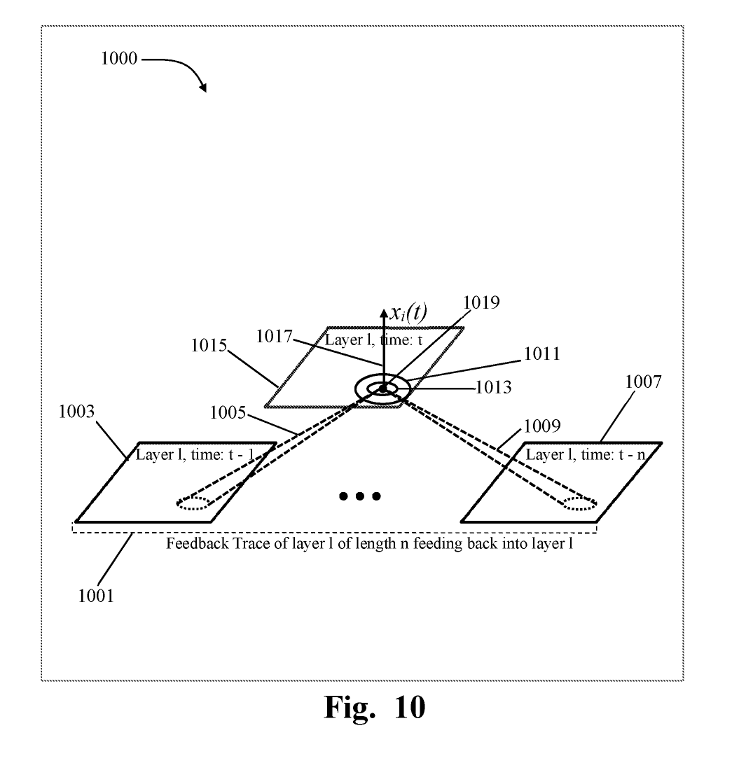

In an embodiment, a spatio-temporal feature analysis apparatus is illustrated in FIG. 8 (800). The input to the apparatus represents an input pattern sequence that comprises one or more digital patterns. Without any loss of generality, the digital input pattern may be a digital image or a processing version of a digital image, and the sequence may represent video frames or processed versions of a video frames. The input is projected through weights to Layer 1 (FIG. 8 (811)) of module FIG. 8 (805), where the projections are based on RFs and strides. The input to these projections need not be from processing elements, or be considered coming from processing elements that have a unity transfer function. Layer 1 (FIG. 8 (811)) may have several topographically aligned sheets of processing elements, which receive projections from location that are topographically organised. These processing elements may also receive lateral projections, and have each an output that represents the activity of the processing element. After an input pattern has been applied, the activity of the processing element is computed in a number of iterations. In each iteration, the processing element processes all its projecting inputs. After these iterations, the activity of the processing element is considered ready to be output, and is made available as output after the current output is saved (FIG. 8 (807)) through the layer's trace (FIG. 8 (813)) in a bucket brigade fashion. Note the trace elements of a layer may themselves be layers that have the same sheet configuration as the layer they are tracing. Further details of trace and elements for a layer l are illustrated in FIG. 9, and show the transfer of the previous outputs of the for previous inputs. Here an input is attached to a time step, which can simply represent the image position in the sequence. Layer FIG. 9 (905) represents the output of layer L for the previous input, and layer FIG. 9 (909) represents the output n-previous inputs earlier. Therefore, layer trace represents the historical output activity of a layer, and because of the topographic organization, the layer and its trace may be considered as a spatio-temporal layer. The trace of a layer may project back to the same layer (e.g. feedback) as illustrated by FIG. 8 (809). It may also project to the next module layer (FIG. 8 (817)) the same way the layer projects to the next layer (FIG. 8 (815)). The spatio-temporal feature analysis apparatus may have multiple layers, each implementing a feature analysis step, and after several of the layers (not fully shown in FIG. 8, but indicated by FIG. 8 (819)), we have the output module with Layer L. Hence FIG. 8 (800) has L layers, each a spatio-temporal layer. The output layer activities represent the features produced by the analysis, and represent the activities of the processing elements in the sheets of layer L. Note a layer and its trace elements (see FIG. 9 (913)) project in a topographically aligned fashion as illustrated by FIGS. 9 (903), (907), and (911) for a processing element in layer l+1 with lateral projections as illustrated by FIG. 9 (917) and FIG. 9 (919), yielding an activity illustrated FIG. 9 (921). The time (t) shown may represent the position of an input pattern (e.g. integer position of pattern in input sequence), and not necessarily a step of an actual time value. We also show illustration of the feedback to a layer from its trace in FIG. 10. Feedback projections are topographically aligned (projections labelled (1005) and (1009) emanate from same source area topographically.

### Embodiment: Method of Recognizing Face Emotions in a Sequence of Images

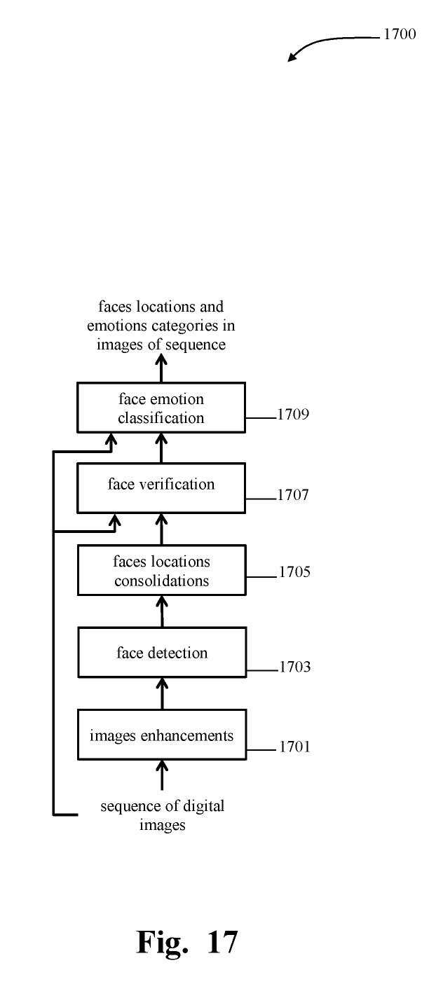

In another embodiment, a method of detecting, locating, consolidating locations, and recognising emotions on human faces in a sequence of one or more digital images, illustrated in FIG. 17 (1700). In the description, we will use the term “still case” to refer to the method of handling an input digital image illustrated in FIG. 3 (300). We also use the term face to indicate a full or partial faces. The images of the input sequence are processed by an images enhancements step (FIG. 17 (1701)), which produces one or more enhanced images for each image in the sequence. The images enhancements step is similar to that of the still case (FIG. 3 (301)) but operates on the input sequence by simply iterating on the sequence of images. Faces are detected by the face detection step (FIG. 17 (1703)) which operates on the enhancements images of each of the images in the input sequence, and the face detection technique is similar to that of the still case (FIG. 3 (303)). The faces locations detected in the enhanced images of each of the image of the input sequence are consolidated by a faces locations consolidations step (FIG. 17 (1705)), which uses a technique similar to the still case (FIG. 3 (305)), but applied to the sequence. The resulting consolidated faces locations will be associated with their image in the input sequence. Some images in the input sequence may or may not have faces locations. The consolidated faces locations together with the input sequence of images are used by the face verification step (FIG. 17 (1707)) to verify that locations associated with faces, are indeed for valid faces, and if not remove the faces locations from further processing. This step is similar to that in FIG. 3 (307) using a face/non-face classifier, but operates on consolidates faces for each image that has detected and consolidated faces in the sequence. The verified faces locations and associated input images from the sequence are then used by the face emotion classification step (FIG. 17 (1709)) to classify the face emotion and produce a facial expression emotion category and/or probable categories, for each detected and verified face location for each image in the sequence. This step is similar to the face emotion classification of that in FIG. 3 (309), but operate on the sequence. The output are the categories and locations of the faces in images of the sequence, where categories are labels and/or probabilistic categories.

### Embodiment: Apparatus for Spatio-Temporal Visual Feature Analysis with Top-Down Modulation

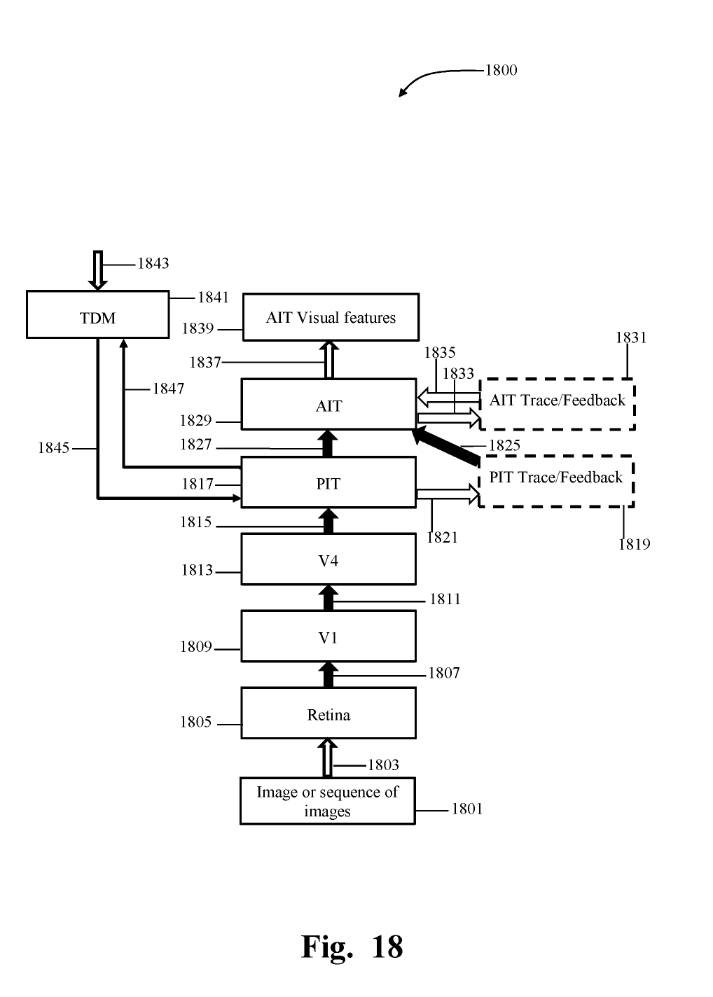

In an embodiment, an apparatus for spatio-temporal visual feature analysis with spatio-temporal capabilities and TDM is illustrated in FIG. 18 (1800). This apparatus is an augmentation of the apparatus illustrated in FIG. 16. (1600) with the addition of modules PIT trace FIG. 18 (1819), AIT (FIG. 18 (1829)), and AIT Trace (FIG. 18 (1831)). The output of the apparatus are visual features in response to a digital image or sequence of digital images. The other modules illustrated in FIG. 18 (1800) are similar to the corresponding modules of the apparatus of FIG. 16 (1600), with the differences being they are operated on an image at the apparatus input, or an image from a sequence of image presented at the apparatus input, the PIT module in FIG. 18 (1817) is capable of transferring the activities of its processing elements to its trace in FIG. 18 (1819), and the output of PIT projecting to the sheets of AIT (FIG. 18 (1829)). Element (1827) in FIG. 18 represents these projections. The AIT module in FIG. 18 has a layer that comprises a sheet of processing elements that receive the projections from PIT. The processing elements of the AIT sheet have lateral projections similar to the processing elements of PIT. The extent of the RFs of AIT is in line with the RFs of biological AIT reported in neuroscience literature, and correspond to about 25 degrees of the visual field. This is a configuration element of the apparatus, like the extend of RFs of other modules with processing elements which also configurable. Note the AIT module also receives projections (FIG. 18 (1825)) from processing elements in sheets of the PIT trace layers (FIG. 18 (1819)), as well as feedback projections (FIG. 18 (1835) from the AIT Trace (FIG. 18 (1831)). All projections into AIT are topographic. Weights of afferent and lateral projections to AIT processing elements can be updated using Hebbian learning rule during learning, with a configurable mode that allows learning on every image of a sequence, or a number of images equal to the trace length of PIT has been presented at the input. Note the weights of the projections into PIT and V4I of module V4 are updated on presentation of every image during learning.

The Hebbian learning allows the projections into AIT (afferent from PIT and PIT trace, lateral and feedback from AIT Trace) to develop rich tuning representations, so its processing elements become responsive to spatio-temporal pattern changes at the input of the apparatus. The output of the apparatus can be used as input to train a classifier of images or sequence of images. Without any loss of generality, these images may represent faces, and the apparatus in this case extract visual spatio-temporal features of the muscles of the face.

### Embodiment: Method of Facial Emotion Recognition in Sequence of Images with Owner Entity Assignment and Category Misclassification Detection and Correction

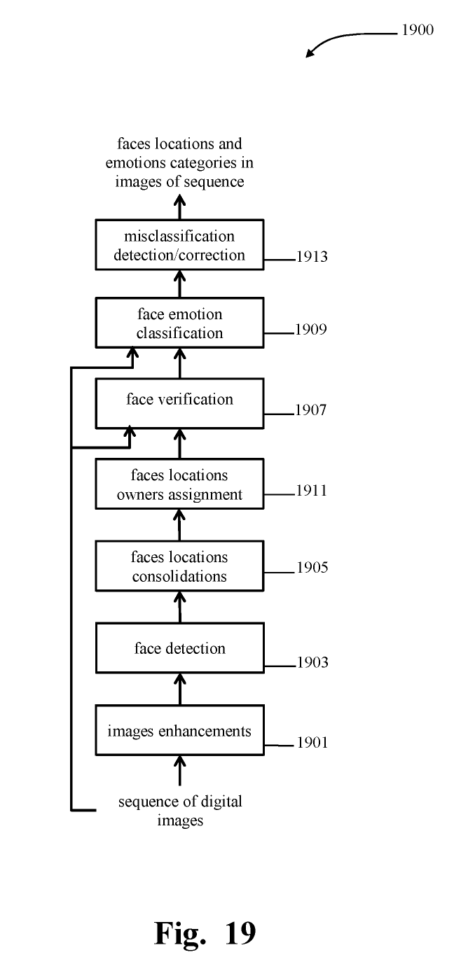

In another embodiment, a method of detecting, locating, recognising, filtering, and correcting misclassifications of facial emotional expressions in a sequence of digital images, is illustrated in FIG. 19 (1900). Again, the term face indicates a full or partial face. This method augments that illustrated in FIG. 17 (1700) by further comprising faces locations owners assignment step and misclassification detection/correction step. The face locations as consolidated by the faces locations consolidations step (FIG. 19 (1905) and is identical to the step in FIG. 17. (1705)), for each image that has detected faces in the sequence of images. A faces locations owners assignment step (FIG. 19 (1911)) scans the sequence of consolidated faces locations and assigns an owner entity to a face location. Face locations within a predefined distance range in preceding or subsequent image in the sequence will share the same unique owner entity. The predefined distance is calculated using a constant, the image position in the sequence, and the shape defining the face location coordinates (e.g. coordinates of rectangle). An owner entity may represent the entity to which a face belongs (human entity). The ownership assignment has a number of benefits. If a face location didn't have an owner in preceding image, nor does it exist, within the region defined by the predetermined distance, in the subsequent image of the sequence, and depending on the image rate (e.g. video frame rate, e.g. number of images or frames per second) of the sequence, it may indicate that the face detected at that location is a spurious pattern that does not represent an actual face (false positive). The number of consecutive images that a face has to persist within a region as defined by the predetermined distance as an acceptable location is programmable, and factors in the image rate (frame rate of the video), the image position in the sequence, and the coordinates of the face location in previous and subsequent image. Another benefit of the owner assignment step is the improved tracking of owners of faces in the sequence. The faces locations owners assignment step may purge owners (and their associated face locations) if they do not persist at least in a desired number of consecutive images. For example, and without any loss of generality, if it is desired than an owner entity persists at least in three consecutive images in the sequence, then any owner entity that doesn't fulfil this condition can be removed from further consideration. The output of the faces locations owners assignment step are the owners and the locations of their faces in images of the sequence. The faces locations of all remaining owners (not filtered out for non-persistence), together with the associated input images from the sequence are used by the face verification step (FIG. 19 (1907)) to verify that locations associated with the faces, are indeed for valid faces, and if not remove them from further processing, similar to step in FIG. 17 (1707). The verified faces locations, the owners, and associated input images from the sequence are then used by the face emotion classification step (FIG. 19 (1909)) to classify the face emotion and produce a face emotion categories probabilities, for each face of remaining owners. The face emotion classifier is identical to that of FIG. 17 (1709). The faces, their owners information, and their categories for each of the images in the sequence are then processed by the misclassification detection/correction step (FIG. 19 (1913)). This step uses a correcting filter to detect and correct classification categories for a face in a sequence of images. Its function is to detect and correct spurious emotion misclassifications of faces in the sequence, regardless of the misclassification reason. The filtering and correction step corrects emotion classification for a face that different within a time period (image rate in sequence) that is considered unlikely (e.g. humans unlikely to change expression back and forth in a 30 milliseconds). The determination of a spurious misclassification and its correction may use the classification categories of the owner faces as predominant before, after, or in both before and after, in the image positions in the sequence. The step uses an X-out-Y sliding filter window and heuristics on the owner's faces classification categories sequence. The step has also the option of using a probabilities-based trellis decoding tree as a filter and correcting technique, which uses the probabilities of each of the face categories as the face emotion classifier step produces for a face, to correct the owner's faces emotion categories sequence in the sequence of images. The output of the step are the corrected categories and locations of the faces in images of the sequence, where categories are labels and/or probabilistic categories. The owners information and associates faces locations in images positions of the sequence are also produced.

### Embodiment: A Processing System for Detecting and Recognizing Facial Emotions in One or More Images

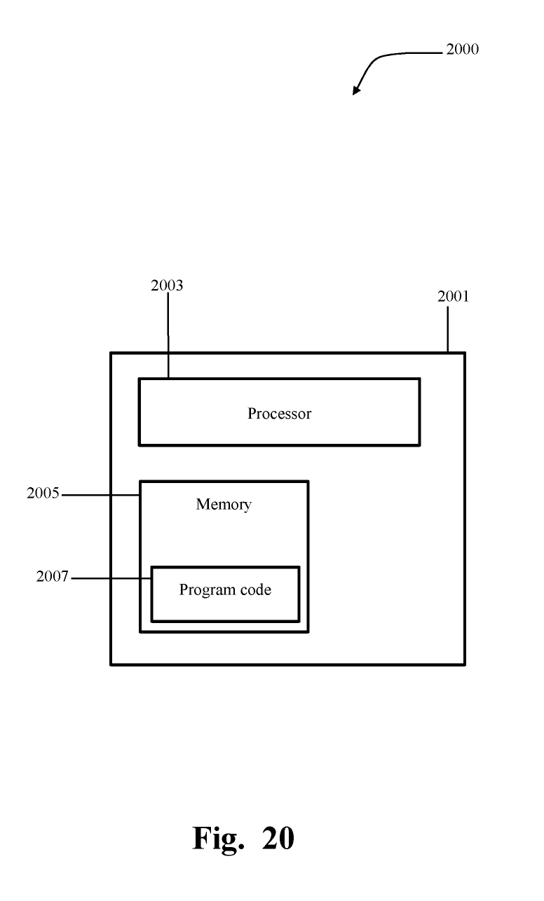

We show in FIG. 20 (2000) a block diagram showing various modules of a data-processing system, a processing system for detecting and recognizing facial emotions in one or more images and sequences of images. The processing system includes a processor (FIG. 20 (2003)) and memory (FIG. 20. (2005)) which includes the program code (FIG. 20 (2007)). The modules may be linked by a fast bus. The processing system, as an option, may include one or more graphic processing units (GPUs) or special processing cards (e.g. comprising FPGA or ASIC) for accelerating the processing.

Particular embodiments of the invention include a non-transitory machine-readable medium coded with instructions, that when executed by a processing system, carry out any one of the above summarized methods.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### General

Unless specifically stated otherwise, as apparent from the following discussions, it is appreciated that throughout the specification discussions utilizing terms such as “processing,” “computing,” “calculating,” “determining” or the like, refer to the action and/or processes of a host device or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory.

The methodologies described herein are, in one embodiment, performable by one or more processors that accept machine-readable instructions, e.g., as firmware or as software, that when executed by one or more of the processors carry out at least one of the methods described herein. In such embodiments, any processor capable of executing a set of instructions (sequential or otherwise) that specify actions to be taken may be included. Thus, one example is a programmable DSP device. Another is the CPU of a microprocessor or other computer-device, or the processing part of a larger ASIC. A processing system may include a memory subsystem including main RAM and/or a static RAM, and/or ROM. A bus subsystem may be included for communicating between the components. The processing system further may be a distributed processing system with processors coupled wirelessly or otherwise, e.g., by a network. If the processing system requires a display, such a display may be included. The processing system in some configurations may include a sound input device, a sound output device, and a network interface device. The memory subsystem thus includes a machine-readable non-transitory medium that is coded with, i.e., has stored therein a set of instructions to cause performing, when executed by one or more processors, one of more of the methods described herein. Note that when the method includes several elements, e.g., several steps, no ordering of such elements is implied, unless specifically stated. The instructions may reside in the hard disk, or may also reside, completely or at least partially, within the RAM and/or other elements within the processor during execution thereof by the system. Thus, the memory and the processor also constitute the non-transitory machine-readable medium with the instructions.

Furthermore, a non-transitory machine-readable medium may form a software product. For example, it may be that the instructions to carry out some of the methods, and thus form all or some elements of the inventive system or apparatus, may be stored as firmware. A software product may be available that contains the firmware, and that may be used to “flash” the firmware.

Note that while some diagram(s) only show(s) a single processor and a single memory that stores the machine-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a non-transitory machine-readable medium coded with, i.e., having stored therein a set of instructions for execution on one or more processors, e.g., one or more processors that are part of the receiver forming a pen stroke capture system.

Note that, as is understood in the art, a machine with application-specific firmware for carrying out one or more aspects of the invention becomes a special purpose machine that is modified by the firmware to carry out one or more aspects of the invention. This is different than a general-purpose processing system using software, as the machine is especially configured to carry out the one or more aspects. Furthermore, as would be known to one skilled in the art, if the number the units to be produced justifies the cost, any set of instructions in combination with elements such as the processor may be readily converted into a special purpose ASIC or custom integrated circuit. Methodologies and software have existed for years that accept the set of instructions and particulars of, for example, the processing engine 131, and automatically or mostly automatically great a design of special-purpose hardware, e.g., generate instructions to modify a gate array or similar programmable logic, or that generate an integrated circuit to carry out the functionality previously carried out by the set of instructions. Thus, as will be appreciated by those skilled in the art, embodiments of the present invention may be embodied as a method, an apparatus such as a special purpose apparatus, an apparatus such as a data DSP device plus firmware, or a non-transitory machine-readable medium. The machine-readable carrier medium carries host device readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form a computer program product on a non-transitory machine-readable storage medium encoded with machine-executable instructions.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a host device system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference, except in those jurisdictions where incorporation by reference is not permitted. In such jurisdictions, the Applicant reserves the right to insert portions of any such cited publications, patents, or patent applications if Applicant considers this advantageous in explaining and/or understanding the disclosure, without such insertion considered new matter.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

The term “image” typically represents a digital representation of an image. It may represent a digital grey scale or colour image with multiple channels, including meta channels such as depth and transparency.

The term “face” represents a full face or a partial part of face, whether obstructed, partially visible, rotated, or truncated, whether intentionally or not.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Note that the claims attached to this description form part of the description, so are incorporated by reference into the description, each claim forming a different set of one or more embodiments.

What is claimed is:

1. A machine-implemented method (100) of recognizing a category of a set of categories of at least one object in at least one digital image, the method comprising:
accepting at least one image into a data-processing machine;
enhancing the at least one digital image to produce one or more enhanced digital images using digital image processing operations that modify at least one of the set of properties consisting of a histogram, a brightness measure, a sharpness measure, and a contrast measure of the at least one digital image;
detecting boundaries of the at least one object in the one or more enhanced digital images;
consolidating the detected boundaries of the at least one object in the one or more enhanced digital images using a heuristic method to remove spurious detections of objects, such that each detected object has an associated location in the image in which it is detected;
determining whether or not each of the at least one detected object is valid using a validity classifier; and
determining a respective category of a set of categories of each respective object of the at least one detected object that is determined to be valid, the determining of the category including applying feature analysis and category classification using the at least one digital image and the boundaries of the at least one detected object,
such that the method changes each of the at least one image into at least one category of at least one detected object in each of the at least one image.

2. The method of claim 1 wherein determining the category of the at least one object determines a category probability measure for the object having the category.

3. The method of claim 1 wherein the at least one object comprises one or more areas of a human body.

4. The method of claim 1 wherein the determining whether or not a detected object is valid uses an artificial neural network classifier trained using a gradient descent supervised machine learning technique.

5. The method of claim 1 wherein the enhancing of a respective image of the at least one digital image comprises adding an enclosing frame of pixels of a pre-calculated color and width.

6. The method of claim 1 wherein the feature analysis comprises calculating visual features using at least one artificial neural network that includes at least one layer, said layer comprising at least one processing element that has an output, one or more afferent projections, and one or more later projections, the processing element calculating its output using one or more of its afferent and lateral projections.

7. The method of claim 6 wherein the artificial neural network is trained using an unsupervised machine learning technique.

8. The method of claim 6 wherein at least one processing element of the artificial neural network receives top-down modulation.

9. The method of claim 7 wherein the unsupervised machine learning technique includes a Hebbian learning technique.

10. The method of claim 1 wherein the feature analysis and the classification of the category determining are combined and implemented using at least one artificial neural network trained using a supervised machine learning technique.

11. The method of claim 1 wherein the accepting the at least one image includes accepting a sequence of images, wherein the method is for recognizing the category of at least one object in the sequence, and wherein the method further comprises:
assigning to an owner entity each detected object and the detected object associated location in the image of the sequence in which it is detected; and
determining and correcting a misclassified object category of particular detected object using three or more of the object categories of the particular detected object assigned to the same owner entity.

12. A machine-implemented method of detecting and recognizing objects in sequence of digital images, the method comprising:
accepting a sequence of one or more digital images;
enhancing the digital images of the sequence to produce one or more enhanced digital images, the enhancing of a digital image comprising using digital image processing operations that modify at least one of the set of properties consisting of a histogram, a brightness measure, a sharpness measure, and a contrast measure of the digital image;
detecting boundaries of at least one object in the one or more enhanced digital images;
consolidating the detected boundaries of objects in the one or more enhanced digital images using a heuristic method to remove spurious detections of objects, such that each detected object has an associated location in the image in which it is detected;
determining whether or not each detected object is a valid object using a validity classifier; and
determining a respective category of a set of categories of each respective object determined to be valid of each detected object, the determining of the category including applying a category classification using the input image associated with the image in which it is detected and the detected object location,
such that the method changes one image in sequence of images into at least one category of at least one detected object in said image.

13. The method of claim 12 further comprising:
assigning to an owner entity each detected object and the detected object associated location in the image of the sequence in which it is detected; and
determining and correcting a misclassified object category of a particular detected object using three or more of the object categories of the particular detected object assigned to the same owner entity.

14. The method of claim 13 wherein each owner entity has a unique identity within the context of a sequence of digital images.

15. An apparatus (1300) for calculating features of a digital image, the apparatus comprising:
a retina module (1301) operative to receive an input digital image and to scale the dimensions and the values of the pixels of the said image;
a V1 module (1321) that comprises a V1S layer (1303) and a V1C layer (1309) that comprise processing elements that are coupled to the retina module;
a V4 module (1323) that comprises a V4I layer and a V4M layer that comprise processing elements that are coupled to V1C module; and
a PIT module (1325) comprising processing elements that are coupled to V4M sheets of the V4 module, and wherein the PIT processing elements are operative to calculate visual features.

16. The apparatus of claim 15 wherein a V4M processing element is operative to implement a maximum calculation operation.

17. The apparatus of claim 15 wherein a weight in a projection connection from a V1 processing element to a V4 processing element is operative to receive a weight modification calculated using the value of said weight and the value of output of said V1 processing element.

18. The apparatus of claim 15 wherein a V4 processing element is operative to receive a projection from a processing element in V4.

19. The apparatus of claim 15 further comprising a module operative to store a trace of the activity of a processing element of PIT.

20. The apparatus of claim 15 further comprising a module operative to provide a top-down modulation signal to a PIT processing element.
